(19) United States
(12) Patent Application Publication
(10) Pub. No.: US 2026/0059084 A1
(43) Pub. Date: Feb. 26, 2026

(54) INFORMATION PROCESSING DEVICE, INFORMATION PROCESSING METHOD, AND COMPUTER-READABLE NON-TRANSITORY STORAGE MEDIUM

(71) Applicant: SONY GROUP CORPORATION, TOKYO (JP)

(72) Inventor: KAORI TAYA, TOKYO (JP)

(21) Appl. No.: 19/104,296

(22) PCT Filed: Jul. 27, 2023
(86) PCT No.: PCT/JP2023/027543

§ 371 Date: Feb. 17, 2025

(30) Foreign Application Priority Data
Aug. 25, 2022 (JP) 2022-134173

(51) Int. Cl. H04N 13/125; G06T 3/18; G06T 5/70

(52) U.S. Cl. CPC H04N 13/125; G06T 3/18; G06T 5/70; G06T 2207/10021

(57) ABSTRACT

An information processing device includes an image transformation unit, a left-right difference estimation unit, and an image generation unit. The image transformation unit performs warping to move positions of a feature point of a right-eye image and a feature point of a left-eye image based on right-eye and left-eye viewpoint information. The left-right difference estimation unit estimates a portion where a difference exceeding an allowable level occurs, due to the warping, between the right-eye image and the left-eye image as an inconsistent portion. The image generation unit makes a sharpness of the inconsistent portion different between the right-eye image and the left-eye image.

### FIELD

The present invention relates to an information processing device, an information processing method, and a computer-readable non-transitory storage medium.

### BACKGROUND

An image generation system that generates 3D images is widely used as reproduction means for movies and the like. In recent years, it has been considered to use this type of image generation system as display means for a partner user in remote communication.

### Citation List

### Patent Literature

Patent Literature 1: JP 2011-082829 A

### SUMMARY

### Technical Problem

When a 3D image is generated from a source image captured by a camera, a direction of a face to be displayed in 3D will be deviated from the front when a position of the camera is deviated from the front. The deviation can be corrected by performing a viewpoint conversion process. The viewpoint conversion process refers to a process of transforming an original image into an image viewed from another imaging perspective by warping. The warping is a homography transformation process in which a position of a specified feature point in an image is moved and transformed into another image.

However, when the viewpoint conversion process is performed, it is necessary to newly generate information on a portion that is not captured in the source image by an image generation process such as a generative adversarial network (GAN). When the generated information is not consistent between a right-eye image and a left-eye image, a binocular rivalry occurs. The binocular rivalry refers to a phenomenon in which, when different visual images are presented to each eye, one of the visual images is perceived first and then the perception switches over time.

Therefore, the present disclosure proposes an information processing device, an information processing method, and a computer-readable non-transitory storage medium capable of performing 3D display in which the binocular rivalry hardly occurs.

### Solution to Problem

According to the present disclosure, an information processing device is provided that comprises: an image transformation unit configured to perform warping to move a position of a feature point of a right-eye image and a position of a feature point of a left-eye image based on viewpoint information of a right eye and a left eye; a left-right difference estimation unit configured to estimate a portion where a difference exceeding an allowable level occurs, due to the warping, between the right-eye image and the left-eye image, as an inconsistent portion; and an image generation unit configured to make a sharpness of the inconsistent portion different between the right-eye image and the left-eye image. According to the present disclosure, an information processing method in which an information process of the information processing apparatus is executed by a computer, and a non-transitory computer-readable storage medium that stores a program for causing the computer to execute the information process of the information processing device, are provided.

### BRIEF DESCRIPTION OF DRAWINGS

FIG. 1 is a schematic diagram illustrating an image generation system.

FIG. 2 is a diagram illustrating an example of a source image and an output image.

FIG. 3 is a diagram illustrating a specific example of a portion where fluctuation occurs in a generation result.

FIG. 4 is a diagram illustrating an example of an information processing device.

FIG. 5 is a diagram illustrating an example of a processing flow regarding an entire process.

FIG. 6 is a diagram illustrating an example of a processing flow regarding a sharpness setting method.

FIG. 7 is a diagram illustrating a processing flow regarding a modification.

FIG. 8 is a diagram illustrating an example of a hardware configuration of the information processing device.

### DESCRIPTION OF EMBODIMENTS

Hereinafter, embodiments of the present disclosure will be described with reference to the drawings. In each of the following embodiments, same parts are given the same reference signs to omit redundant description.

Note that the description will be given in the
[1. Image generation system]
[2. Configuration of information processing device]
[3. Information processing method]
[4. Effects]
[5. Modification]
[6. Hardware configuration example]

### 1. Image Generation System

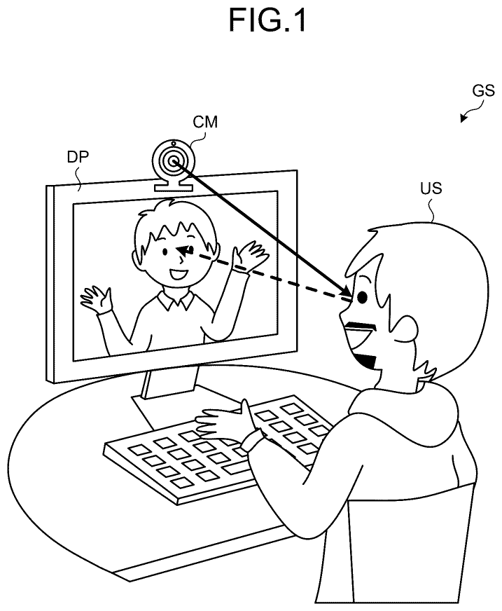

FIG. 1 is a schematic diagram of an image generation system GS.

The image generation system GS is a system that generates a 3D image of users US to support remote communication between the users US. The image generation system GS is applied to, for example, bidirectional telepresence using a 3D display.

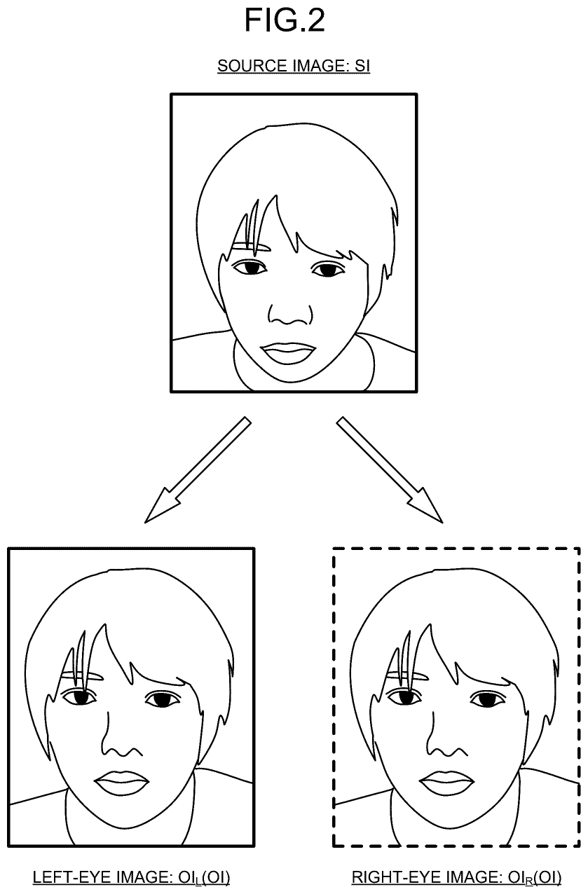

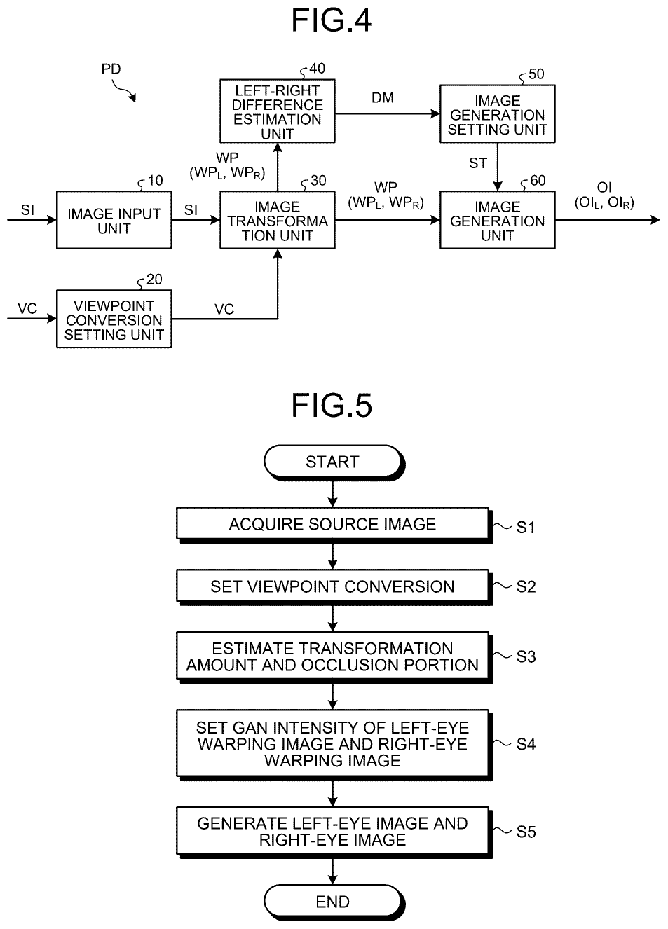

The image generation system GS includes a camera CM, a display DP, and an information processing device PD (see FIG. 4). The camera CM acquires a 2D image of the user US as a source image SI (see FIG. 2). The display DP performs 3D display of the user US on a communication partner side. The camera CM is mounted on an upper end of a display screen. The user US performs communication while looking at the user US on the partner side displayed on the display DP.

The information processing device PD performs a viewpoint conversion process on the source image SI acquired from the camera CM to generate an output image OI (right-eye image OI_{R} and left-eye image OI_{L}) for 3D display (see FIG. 2). FIG. 2 is a diagram illustrating an example of the source image SI and the output image OI.

To achieve the bidirectional telepresence using the 3D display, it is desired to display a face of the user and a face of the partner captured by the camera CM in 3D with reality. However, since the actual camera CM can be placed only in a place deviated in the screen, there is a problem that the viewpoint is deviated. In the example in FIG. 2, the camera CM is mounted on the upper end of the display DP. Therefore, a visual line of the user US in the source image SI is directed downward. As the output image OI, an image in which the visual line is facing forward is preferable, but the source image SI is not such an image.

As a hardware solution, there is a method of embedding the camera CM below the screen or performing photographing by reflecting an image with a half mirror (See, for example, JP 2007-028663 A). However, in this method, a device becomes expensive or large.

As a signal-processing solution, there is a method of 3D modeling and moving a person. However, in this method, details are lost, and the reality is impaired (See, e.g., Saito, Shunsuke, et. al., 2021. “SCANimate: Weakly Supervised Learning of Skinned Clothed Avatar Networks”).

As another signal-processing solution, there is a method of warping an image. However, since one camera CM has many blind spots, two to three cameras are usually necessary. In addition, since the image is stretched when transformation is large, a resolution is lowered (See, e.g., Tal Hassner. et. al., “Effective Face Frontalization in Unconstrained Images”, CVPR, June 2015).

Furthermore, there is also a method of improving sharpness of a composite image by an image generation technology (GAN) by a deep neural network (DNN) based on image warping (See, e.g., Wang et. al., 2020. “One-Shot Free-View Neural Talking-Head Synthesis for Video Conferencing.”, CVPR 2021).

However, when an image with high sharpness is generated using the GAN, inconsistency may occur between the right-eye image OI_{R} and the left-eye image OI_{L}, thereby causing binocular rivalry. In particular, the inconsistency between the right-eye image OI_{R} and the left-eye image OI_{L} is likely to occur in a portion where a high-frequency component is generated from a portion where high-frequency source information is absent such as an occlusion portion or a portion with large transformation due to warping. Therefore, a problem of the binocular rivalry becomes apparent.

Thus, in the present disclosure, the sharpness of only one of the right-eye image OI_{R} and the left-eye image OI_{L} is suppressed in a portion where a left-right difference is likely to occur in an image generated by a learning-based image generation means (e.g., GAN). The left-right difference refers to an image difference between the right-eye image OI_{R} and the left-eye image OI_{L}. By suppressing the sharpness of the image of only one eye, it is possible to suppress the binocular rivalry without impairing the subjective sharpness. The binocular rivalry can be suppressed by suppressing the sharpness of the image of one eye because, when one eye is blurred and the other eye is sharp, human eyes have a property of complementing the image in the head by adopting a sharper picture (See, for example, JP 2011-082829 A).

Here, the sharpness refers to the number of high frequency components in the image. In the model-based image processing method, it is difficult to restore the frequency equal to or higher than the Nyquist frequency, but in the learning-based image generation means (e.g., GAN), high frequency components equal to or higher than the Nyquist frequency can be restored by learning a large amount of image structures. However, the restoration does not exactly match the source image, and a different high-frequency image may be generated depending on differences in low-frequency images input.

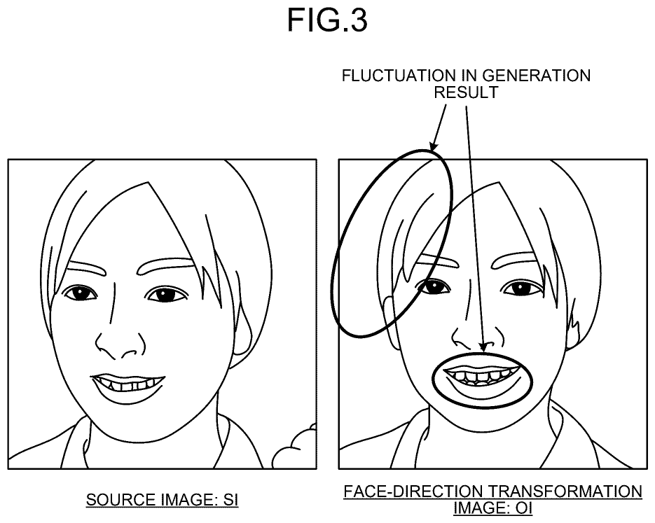

FIG. 3 is a diagram illustrating a specific example of a portion where fluctuation occurs in a generation result.

The left side of FIG. 3 is an image of a woman (source image SI) whose visual line is slightly inclined to the left, and the right side of FIG. 3 is an image (output image OI) obtained by frontalizing a face direction by warping. In the example in FIG. 3, the face direction is transformed using an image generation technique called a first order motion model (FOMM) (e.g., “First Order Motion Model for Image Animation”, Aliaksandr Siarohin, Stephane Lathuiliere, Sergey Tulyakov, Elisa Ricci and Nicu Sebe, NeurIPS 2019).

The FOMM is known as the technique of creating a moving image from a still image in real time based on a reference moving image. Each frame of the reference moving image is used as a driving frame for moving feature points of the still image. In the FOMM, a plurality of key points to be feature points are extracted from a person in a driving frame and a person in a still image, respectively, and a movement of a face and body of the person in the driving frame is applied to the person in the still image based on a correspondence relation between the key points. By preparing an image facing the front as the driving frame, it is possible to generate the output image OI in which the face of the person in the source image SI is frontalized.

Image processing by the FOMM is performed using a generative model such as the GAN. The generative model refers to a neural network that obtains a high-order inference result from low-order input information. The generative model can newly generate a signal having a high-frequency component not included in the input signal based on a learning result. A generative model having a higher capability of generating a signal (generating capability) can generate an image with higher In the example in FIG. 3, a portion of hair on the left side of the output image OI is a portion not visible from a photographing viewpoint of the source image SI. Therefore, information on this portion is newly generated by the generative model. A portion of mouth (e.g., a part of teeth) is also not visible from the photographing viewpoint of the source image SI, and this portion is also newly generated by the generative model.

Image information of the newly generated portion is uncertain information obtained through a complicated calculation process related to viewpoint conversion. Therefore, when the transformation process for a different direction is performed, there is a possibility that a generated image will also be a different image. Since there is fluctuation in the generation result, there is a possibility that inconsistency occurs between the right-eye image OI_{R} and the left-eye image OI_{L} in the above-described portion when the right-eye image OI_{R} and the left-eye image OI_{L} are generated from the source image SI. Therefore, in the present disclosure, a portion where the left-right difference is large and inconsistency is likely to be recognized is identified as an inconsistent portion, and the sharpness of only one of the right-eye image OI_{R} and the left-eye image OI_{L} is suppressed in the inconsistent portion. Details will be described below.

### 2. Configuration of Information Processing Device

FIG. 4 is a diagram illustrating an example of the information processing device PD.

The information processing device PD performs the viewpoint conversion process on the source image SI to generate the output image OI (right-eye image OI_{R} and left-eye image OI_{L}) for 3D display. The information processing device PD includes an image input unit 10, a viewpoint conversion setting unit 20, an image transformation unit 30, a left-right difference estimation unit 40, an image generation setting unit 50, and an image generation unit 60.

The image input unit 10 acquires the source image SI from the camera CM. The source image SI may be RGB-format data or YUV-format data. The viewpoint conversion setting unit 20 acquires viewpoint information VC of the right eye and the left eye. The viewpoint information VC includes information on a viewpoint position corresponding to the right eye and information on a viewpoint position corresponding to the left eye. The viewpoint position is defined by, for example, a rotation amount and a translation amount of the viewpoint position with respect to the photographing viewpoint of the source image SI. The viewpoint information VC may be acquired from user input information or may be acquired from default information.

The image transformation unit 30 performs warping to move positions of a feature point of the right-eye image OI_{R} and a feature point of the left-eye image OI_{L} based on the viewpoint information VC of the right eye and the left eye. The image transformation unit 30 warps the source image SI based on the viewpoint information VC, and generates a right-eye warping image WPR and a left-eye warping image WPL as a warping image WP.

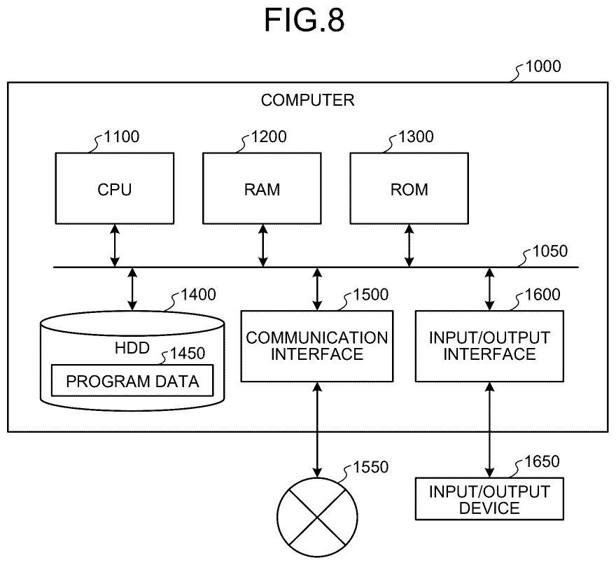

For example, the image transformation unit 30 acquires a driving frame for the right eye and a driving frame for the left eye matching the viewpoint information VC from registration data stored in an HDD 1400 (see FIG. 8). The image transformation unit 30 extracts a plurality of key points from each of the source image SI and the driving frame. The image transformation unit 30 warps the source image SI based on the correspondence relation between the key points of the source image SI and the key points of the driving frame, respectively.

The warping is performed as follows. The image transformation unit 30 performs affine transformation on an image region near the key points of the source image SI based on the correspondence relation between the key points. As a result, the affine transformation image is obtained for each of the key points. The image transformation unit 30 combines all the affine transformation images to generate the warping image WP. The warping image WP includes information on an image feature amount of the source image SI after the warping.

The image transformation unit 30 identifies a portion not visible from the photographing viewpoint of the source image SI as an occlusion portion, and generates an occlusion map defining a distribution of the occlusion portion. The image transformation unit 30 generates a right-eye occlusion map from a right-eye warping image WPR, and generates a left-eye occlusion map from a left-eye warping image WPL. The right-eye occlusion map is an occlusion map in which the occlusion portion is identified in the right-eye warping image WPR. The left-eye occlusion map is an occlusion map in which the occlusion portion is identified in the left-eye warping image WPL.

The left-right difference estimation unit 40 estimates a portion where a difference exceeding an allowable level occurs, due to the warping, between the right-eye image OI_{R} and the left-eye image OI_{L} as the inconsistent portion. The inconsistent portion is a portion having a large left-right difference and in which binocular rivalry is likely to occur. The left-right difference estimation unit 40 can estimate the inconsistent portion based on the right-eye occlusion map and the left-eye occlusion map. The left-right difference estimation unit 40 generates a distribution of the inconsistent portion as a left-right difference map DM.

As described above, the warping image WP includes the information on the image feature amount. Therefore, it is possible to easily identify which portion of the warping image WP has a large transformation amount by the warping. In addition, whether or not the portion having a large transformation amount includes a large amount of high-frequency components can be determined by a known method such as edge extraction or discrete cosine transform. Therefore, the inconsistent portion can also be identified based on these pieces of information.

For example, the image transformation unit 30 calculates the transformation amount from the source image SI for each position, and generates a distribution of the transformation amount as transformation information. The image transformation unit 30 generates right-eye transformation information from the right-eye warping image WPR, and generates left-eye transformation information from the left-eye warping image WPL. The right-eye transformation information is information identifying the distribution of the transformation amount in the right-eye warping image WPR. The left-eye transformation information is information identifying the distribution of the transformation amount in the left-eye warping image WPL. The left-right difference estimation unit 40 can estimate the inconsistent portion based on the right-eye transformation information and the left-eye transformation information.

For example, the left-right difference estimation unit 40 estimates a portion where the transformation amount from the source image SI exceeds an allowable range as the inconsistent portion. The allowable range can be arbitrarily set by a system developer based on a sensory test or the like. The left-right difference estimation unit 40 may also estimate, as the inconsistent portion, a region (high frequency region) in which a portion having a spatial frequency exceeding a threshold (high frequency component) spreads at a density and in a range exceeding a reference level among portions where the transformation amount from the source image SI exceeds the allowable range. The system developer can arbitrarily set the spatial frequency, the density, and the range of the high frequency region determined to be the inconsistent portion.

The image generation setting unit 50 sets a magnitude of the sharpness for each position based on the left-right difference map DM. The image generation setting unit 50 sets the sharpness of the inconsistent portion higher than that of a portion other than the inconsistent portion. The sharpness of the inconsistent portion may be varied according to the magnitude of the left-right difference. The image generation setting unit 50 generates a distribution of the magnitude of the sharpness as setting information ST.

Based on the user input information, the image generation setting unit 50 determines which one of the right-eye image OI_{R} and the left-eye image OI_{L} is to be an image with high sharpness and how much sharpness is to be different between the right-eye image OI_{R} and the left-eye image OI_{L}, and includes the determination in the setting information ST. Which one of the right-eye image OI_{R} and the left-eye image OI_{L} is to be the image with higher sharpness can be determined based on, for example, a larger transformation amount, larger occlusion, or non-dominant eye.

The image generation unit 60 generates the right-eye image OI_{R} and the left-eye image OI_{L} from the right-eye warping image WPR and the left-eye warping image WPL using the generative model such as the GAN. The warping image WP is an image distorted with respect to the source image SI. The generative model performs a process of reducing distortion of the warping image WP and creating the warping image WP as a realistic image based on the learning result.

Based on the setting information ST, the image generation unit 60 sets the generating capability of the generative model for each position for each of the right-eye warping image WPR and the left-eye warping image WPL. When the image generation process is performed by the GAN, the image generation is performed by partially switching between a sharpened image generation parameter in which a weight of an adversarial loss is set high and a smooth image generation parameter in which the weight of the adversarial loss is set low, so that the generating capability can be made different for each position. Smoothing is a state in which there are few high frequency components.

The image generation unit 60 adjusts the sharpness by making the generating capability of the generative model for the inconsistent portion different between the right-eye image OI_{R} and the left-eye image OI_{L}. For example, the image generation unit 60 sets the generating capability to be high for a portion for which the sharpness is set to be high, and sets the generating capability to be low for a portion for which the sharpness is set to be low. As a result, the image generation unit 60 makes the sharpness of the inconsistent portion different between the right-eye image OI_{R} and the left-eye image OI_{L}. The image generation unit 60 can weigh the occlusion portion based on the occlusion map.

### 3. Information Processing Method

FIG. 5 is a diagram illustrating an example of a processing flow regarding an entire process.

The image input unit 10 acquires the source image SI from the camera CM (Step S1). The viewpoint conversion setting unit 20 sets the viewpoint conversion and generates the viewpoint information VC (Step S2). The image transformation unit 30 performs the warping of the source image SI based on the viewpoint information VC. The image transformation unit 30 estimates the transformation amount and the occlusion portion for each position in each of the right-eye warping image WPR and the left-eye warping image WPL (Step S3). The left-right difference estimation unit 40 generates the left-right difference map DM based on the estimation result.

The image generation unit 60 sets a GAN intensity (generating capability) for each position in each of the right-eye warping image WPR and the left-eye warping image WPL based on the left-right difference map DM (Step S4). The image generation unit 60 sets the GAN intensity such that the sharpness of the inconsistent portion is different between the right-eye image OI_{R} and the left-eye image OI_{L}. The image generation unit 60 generates the right-eye image OI_{R} and the left-eye image OI_{L} based on the set GAN intensity (Step S5).

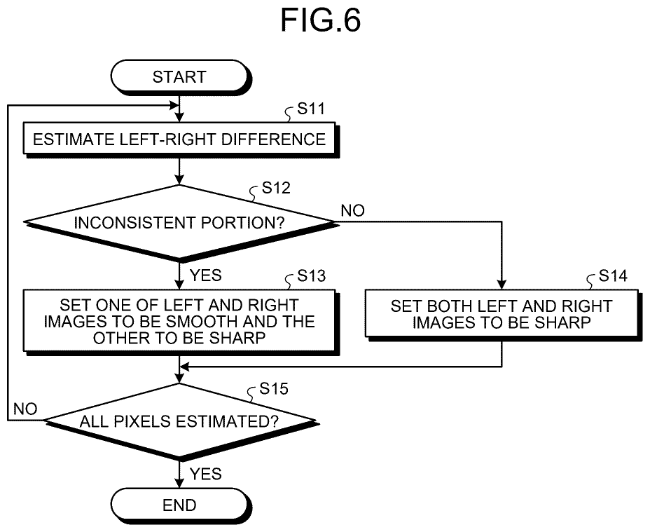

FIG. 6 is a diagram illustrating an example of a processing flow regarding a sharpness setting method.

The left-right difference estimation unit 40 estimates the left-right difference for each pixel based on the occlusion map, the transformation information of the warping image WP, and the like (Step S11). The left-right difference estimation unit 40 determines whether a pixel to be estimated is an inconsistent portion having a large left-right difference (Step S12).

When the pixel to be estimated is the inconsistent portion (Step S12: Yes), the left-right difference estimation unit 40 sets, for the pixel, the GAN intensity of one of the right-eye warping image WPR and the left-eye warping image WPL to be smooth and sets the GAN intensity of the other to be sharp (Step S13). When the pixel to be estimated is not the inconsistent portion (Step S12: No), the left-right difference estimation unit 40 sets, for the pixel, the GAN intensity of both the right-eye warping image WPR and the left-eye warping image WPL to be sharp (Step S14).

The left-right difference estimation unit 40 determines whether the estimation process has been completed for all the pixels (Step S15). If there is a pixel for which the estimation process has not been completed (Step S15: No), the left-right difference estimation unit 40 returns to Step S11 and repeats the above-described process until the estimation process of all the pixels is completed.

The above-described process may be executed in parallel. In addition, the image may be divided into a plurality of small areas, and division processing may be performed on each of the small areas.

### 4. Effects

The information processing device PD includes the image transformation unit 30, the left-right difference estimation unit 40, and the image generation unit 60. The image transformation unit 30 performs the warping to move positions of the feature point of the right-eye image OI_{R} and the feature point of the left-eye image OI_{L} based on the viewpoint information VC of the right eye and the left eye. The left-right difference estimation unit 40 estimates a portion where a difference exceeding the allowable level occurs, due to the warping, between the right-eye image OI_{R} and the left-eye image OI_{L} as the inconsistent portion. The image generation unit 60 makes the sharpness of the inconsistent portion different between the right-eye image OI_{R} and the left-eye image OI_{L}. In the information processing method of the present disclosure, the process of the information processing device PD is executed by a computer 1000 (see FIG. 8). A computer-readable non-transitory storage medium of the present disclosure stores a program for causing the computer 1000 to implement the process of the information processing device PD.

According to this configuration, it is possible to suppress the binocular rivalry without deteriorating sharpness felt by human by utilizing a human visual characteristic that a whole image looks sharp when one image is sharp even though the other image is not sharp.

The image transformation unit 30 warps the source image SI based on the viewpoint information VC to generate the right-eye warping image WPR and the left-eye warping image WPL. The image generation unit 60 generates the right-eye image OI_{R} and the left-eye image OI_{L} from the right-eye warping image WPR and the left-eye warping image WPL using the generative model.

According to this configuration, high-order output information (right-eye image OI_{R} and left-eye image OI_{L}) is obtained from low-order input information (right-eye warping image WPR and left-eye warping image WPL) by the generative model. Therefore, high-quality 3D display can be obtained.

The image transformation unit 30 generates the right-eye occlusion map and the left-eye occlusion map. The right-eye occlusion map is the occlusion map that identifies a portion of the right-eye warping image WPR that is not visible from the photographing viewpoint of the source image SI. The left-eye occlusion map is the occlusion map that identifies a portion of the left-eye warping image WPL that is not visible from the photographing viewpoint of the source image SI. The left-right difference estimation unit 40 estimates the inconsistent portion based on the right-eye occlusion map and the left-eye occlusion map.

According to this configuration, the inconsistent portion is appropriately estimated based on the occlusion map.

The image transformation unit 30 generates the right-eye transformation information and the left-eye transformation information. The right-eye transformation information is information identifying the distribution of the transformation amount from the source image SI in the right-eye warping image WPR. The left-eye transformation information is information identifying the distribution of the transformation amount from the source image SI in the left-eye warping image WPL. The left-right difference estimation unit 40 estimates the inconsistent portion based on the right-eye transformation information and the left-eye transformation information.

According to this configuration, the inconsistent portion is appropriately estimated based on the transformation amount.

The left-right difference estimation unit 40 estimates the portion where the transformation amount from the source image SI exceeds the allowable range as the inconsistent portion.

According to this configuration, the inconsistent portion is appropriately estimated based on a positive correlation existing between the transformation amount and the generating capability.

The left-right difference estimation unit 40 estimates, as the inconsistent portion, a region (high frequency region) in which a portion having a spatial frequency exceeding a reference value spreads at a density and in a range exceeding a reference level among portions where the transformation amount from the source image SI exceeds the allowable range.

According to this configuration, the binocular rivalry in the high frequency region where the left-right difference is easily noticeable is appropriately suppressed.

The image generation unit 60 adjusts the sharpness by making the generating capability of the generative model for the inconsistent portion different between the right-eye image OI_{R} and the left-eye image OI_{L}.

According to this configuration, the fidelity with respect to the source image SI changes depending on the strength of the generating capability. The lower the generating capability is, the more fidelity the source image SI has. By reducing the generating capability of the inconsistent portion, it is possible to increase the fidelity of the output image OI while suppressing the binocular rivalry.

The information processing device PD includes the image generation setting unit 50. Based on the user input information, the image generation setting unit 50 determines which one of the right-eye image OI_{R} and the left-eye image OI_{L} is to be an image with higher sharpness, and determines how much sharpness is to be different between the right-eye image OI_{R} and the left-eye image OI_{L}.

According to this configuration, appropriate image processing in consideration of individual differences of the users US is performed.

Note that the effects described in the present specification are merely examples and not limited, and other effects may be provided.

### 5. Modification

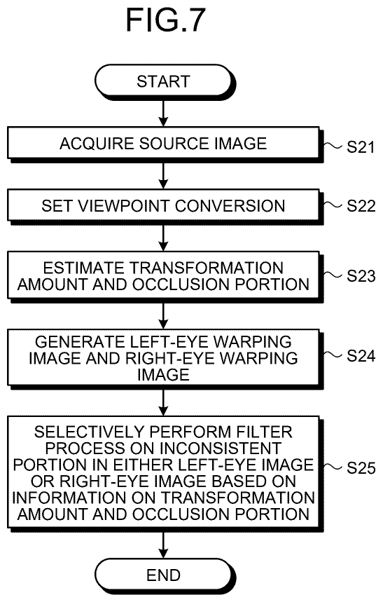

FIG. 7 is a diagram illustrating a processing flow regarding a modification.

In FIG. 7, Steps S21 to S23 are the same as Steps S1 to S3 illustrated in FIG. 5. In the above-described embodiment, the image generation unit 60 adjusts the sharpness by making the generating capability of the generative model for the inconsistent portion different between the right-eye image OI_{R} and the left-eye image OI_{L}.

On the other hand, in the present modification, the image generation unit 60 adjusts the sharpness by selectively performing a blurring process on the inconsistent portion of either the right-eye image OI_{R} or the left-eye image OI_{L}. As the blurring process, a filtering process such as a Gaussian filter is used. It is possible to expand blurring by increasing a o value of the Gaussian filter or a size of the filter.

For example, the image generation unit 60 performs the generation process without making a difference in the generating capability between the inconsistent portion and the portion other than the inconsistent portion. The image generation unit 60 sets all portions to be sharp and generates the right-eye image OI_{R} and the left-eye image OI_{L} (Step S24).

The image generation unit 60 selectively performs the filter process on the inconsistent portion in either the right-eye image or the left-eye image based on the information on the transformation amount and the information on the occlusion portion for each position (Step S25). After generating the right-eye image OI_{R} and the left-eye image OI_{L}, the image generation unit 60 selectively performs the blurring process on the inconsistent portion as post-processing. Even with this configuration, it is possible to suppress the binocular rivalry while enhancing sharpness.

### 6. Hardware Configuration Example

FIG. 8 is a diagram illustrating an example of a hardware configuration of the information processing device PD.

The information processing of the information processing device PD is realized by, for example, the computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program (program data 1450) stored in the ROM 1300 or the HDD 1400, and controls each unit. For example, the CPU 1100 develops a program stored in the ROM 1300 or the HDD 1400 into the RAM 1200, and executes processes corresponding to various programs.

The ROM 1300 stores a boot program such as a basic input output system (BIOS) executed by the CPU 1100 when the computer 1000 is activated, a program dependent on hardware of the computer 1000, and the like.

The HDD 1400 is a computer-readable non-transitory recording medium that non-transiently records a program executed by the CPU 1100, data used by the program, and the like. Specifically, the HDD 1400 is a recording medium that records an information processing program according to the embodiment as an example of the program data 1450.

The communication interface 1500 is an interface for the computer 1000 to connect to an external network 1550 (e.g., the Internet). For example, the CPU 1100 receives data from another apparatus or transmits data generated by the CPU 1100 to another apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display device, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as the information processing device PD according to the embodiment, the CPU 1100 of the computer 1000 executes the information processing program loaded on the RAM 1200 to implement the functions of the above-described units. In addition, the HDD 1400 stores the information processing program, various models, and various pieces of data according to the present disclosure. The CPU 1100 reads the program data 1450 from the HDD 1400 and executes the program data 1450. As another example, these programs may be acquired from another device via the external network 1550.

### Supplementary Note

The present technology may also have the following configurations.

(1)

An information processing device comprising:
an image transformation unit configured to perform warping to move a position of a feature point of a right-eye image and a position of a feature point of a left-eye image based on viewpoint information of a right eye and a left eye;
a left-right difference estimation unit configured to estimate a portion where a difference exceeding an allowable level occurs, due to the warping, between the right-eye image and the left-eye image, as an inconsistent portion; and
an image generation unit configured to make a sharpness of the inconsistent portion different between the right-eye image and the left-eye image.
   (2)

The information processing device according to (1), wherein
the image transformation unit generates a right-eye warping image and a left-eye warping image by warping a source image based on the viewpoint information, and
the image generation unit generates the right-eye image and the left-eye image from the right-eye warping image and the left-eye warping image using a generative model.
   (3)

The information processing device according to (2), wherein
the image transformation unit generates a right-eye occlusion map in which a portion not visible from a photographing viewpoint of the source image is identified in the right-eye warping image, and a left-eye occlusion map in which a portion not visible from a photographing viewpoint of the source image is identified in the left-eye warping image, and
the left-right difference estimation unit estimates the inconsistent portion based on the right-eye occlusion map and the left-eye occlusion map.
   (4)

The information processing device according to (2), wherein
the image transformation unit generates right-eye transformation information identifying a distribution of transformation amount from the source image in the right-eye warping image and left-eye transformation information identifying a distribution of transformation amount from the source image in the left-eye warping image, and
the left-right difference estimation unit estimates the inconsistent portion based on the right-eye transformation information and the left-eye transformation information.
   (5)

The information processing device according to (4), wherein
the left-right difference estimation unit estimates, as the inconsistent portion, a portion where the transformation amount from the source image exceeds an allowable range.
   (6)

The information processing device according to (5), wherein
the left-right difference estimation unit estimates, as the inconsistent portion, a region in which a portion having a spatial frequency exceeding a reference value spreads at a density and in a range exceeding a reference level in the portion where the transformation amount from the source image exceeds the allowable range.
   (7)

The information processing device according to any one of (2) to (6), wherein
the image generation unit adjusts the sharpness by making a generating capability of the generative model for the inconsistent portion different between the right-eye image and the left-eye image.
   (8)

The information processing device according to any one of (2) to (6), wherein
the image generation unit adjusts the sharpness by selectively performing a blurring process on the inconsistent portion of either the right-eye image or the left-eye image.
   (9)

The information processing device according to any one of (1) to (8), further comprising:
an image generation setting unit configured to determine, based on user input information, which one of the right-eye image and the left-eye image is to be an image with high sharpness and how much sharpness is to be different between the right-eye image and the left-eye image.
   (10)

An information processing method executed by a computer, the information processing method comprising:
performing warping to move a position of a feature point of a right-eye image and a position of a feature point of a left-eye image based on viewpoint information of a right eye and a left eye;
estimating a portion where a difference exceeding an allowable level occurs, due to the warping, between the right-eye image and the left-eye image, as an inconsistent portion; and
making a sharpness of the inconsistent portion different between the right-eye image and the left-eye image.
   (11)

A non-transitory computer-readable storage medium storing a program causing a computer to implement:
performing warping to move a position of a feature point of a right-eye image and a position of a feature point of a left-eye image based on viewpoint information of a right eye and a left eye;
estimating a portion where a difference exceeding an allowable level occurs, due to the warping, between the right-eye image and the left-eye image, as an inconsistent portion; and
making a sharpness of the inconsistent portion different between the right-eye image and the left-eye image.

### REFERENCE SIGNS LIST

30 IMAGE TRANSFORMATION UNIT
40 LEFT-RIGHT DIFFERENCE ESTIMATION UNIT
50 IMAGE GENERATION SETTING UNIT
60 IMAGE GENERATION UNIT
OI_{L} LEFT-EYE IMAGE
OI_{R} RIGHT-EYE IMAGE
PD INFORMATION PROCESSING DEVICE
SI SOURCE IMAGE
VC VIEWPOINT INFORMATION
WPL LEFT-EYE WARPING IMAGE
WPR RIGHT-EYE WARPING IMAGE

1. An information processing device comprising:
an image transformation unit configured to perform warping to move a position of a feature point of a right-eye image and a position of a feature point of a left-eye image based on viewpoint information of a right eye and a left eye;
a left-right difference estimation unit configured to estimate a portion where a difference exceeding an allowable level occurs, due to the warping, between the right-eye image and the left-eye image, as an inconsistent portion; and
an image generation unit configured to make a sharpness of the inconsistent portion different between the right-eye image and the left-eye image.

2. The information processing device according to claim 1, wherein
the image transformation unit generates a right-eye warping image and a left-eye warping image by warping a source image based on the viewpoint information, and
the image generation unit generates the right-eye image and the left-eye image from the right-eye warping image and the left-eye warping image using a generative model.

3. The information processing device according to claim 2, wherein
the image transformation unit generates a right-eye occlusion map in which a portion not visible from a photographing viewpoint of the source image is identified in the right-eye warping image, and a left-eye occlusion map in which a portion not visible from a photographing viewpoint of the source image is identified in the left-eye warping image, and
the left-right difference estimation unit estimates the inconsistent portion based on the right-eye occlusion map and the left-eye occlusion map.

4. The information processing device according to claim 2, wherein
the image transformation unit generates right-eye transformation information identifying a distribution of transformation amount from the source image in the right-eye warping image and left-eye transformation information identifying a distribution of transformation amount from the source image in the left-eye warping image, and
the left-right difference estimation unit estimates the inconsistent portion based on the right-eye transformation information and the left-eye transformation information.

5. The information processing device according to claim 4, wherein
the left-right difference estimation unit estimates, as the inconsistent portion, a portion where the transformation amount from the source image exceeds an allowable range.

6. The information processing device according to claim 5, wherein
the left-right difference estimation unit estimates, as the inconsistent portion, a region in which a portion having a spatial frequency exceeding a reference value spreads at a density and in a range exceeding a reference level in the portion where the transformation amount from the source image exceeds the allowable range.

7. The information processing device according to claim 2, wherein
the image generation unit adjusts the sharpness by making a generating capability of the generative model for the inconsistent portion different between the right-eye image and the left-eye image.

8. The information processing device according to claim 2, wherein
the image generation unit adjusts the sharpness by selectively performing a blurring process on the inconsistent portion of either the right-eye image or the left-eye image.

9. The information processing device according to claim 1, further comprising:
an image generation setting unit configured to determine, based on user input information, which one of the right-eye image and the left-eye image is to be an image with high sharpness and how much sharpness is to be different between the right-eye image and the left-eye image.

10. An information processing method executed by a computer, the information processing method comprising:
performing warping to move a position of a feature point of a right-eye image and a position of a feature point of a left-eye image based on viewpoint information of a right eye and a left eye;
estimating a portion where a difference exceeding an allowable level occurs, due to the warping, between the right-eye image and the left-eye image, as an inconsistent portion; and
making a sharpness of the inconsistent portion different between the right-eye image and the left-eye image.

11. A non-transitory computer-readable storage medium storing a program causing a computer to implement:
performing warping to move a position of a feature point of a right-eye image and a position of a feature point of a left-eye image based on viewpoint information of a right eye and a left eye;
estimating a portion where a difference exceeding an allowable level occurs, due to the warping, between the right-eye image and the left-eye image, as an inconsistent portion; and
making a sharpness of the inconsistent portion different between the right-eye image and the left-eye image.
